(19) United States
(12) Patent Application Publication
(10) Pub. No.: US 2026/0151810 A1
(43) Pub. Date: Jun. 4, 2026

(54) ULTRA-THIN METAL STRIP WITH SUPERFICIAL MICRO-CUP ARRAY STRUCTURE AND PREPARATION METHOD THEREOF

(71) Applicant: Taiyuan University of Technology, Taiyuan City (CN)

(72) Inventors: Jingwei Zhao, Taiyuan City (CN); Chen Wang, Taiyuan City (CN); Panyue Chen, Taiyuan City (CN); Xiaoguang Ma, Taiyuan City (CN)

(21) Appl. No.: 19/059,807

(22) Filed: Feb. 21, 2025

(30) Foreign Application Priority Data
Dec. 3, 2024 (CN) 202411764221.6

(51) Int. Cl. B21B 1/22; B32B 3/30; B32B 15/01; B32B 15/20; C21D 8/02; C21D 9/52

(52) U.S. Cl. CPC B21B 1/227; B32B 3/30; B32B 15/015; B32B 15/20; C21D 8/02; C21D 8/0247; C21D 9/52; B32B 2307/7376

(57) ABSTRACT

An ultra-thin metal strip with a superficial micro-cup array structure and a preparation method thereof are provided. The preparation method includes: S1, cutting an ultra-thin metal strip and a highly elastic rubber to obtain a metal substrate and a highly elastic rubber strip; S2, subjecting the metal substrate to pre-rolling annealing to obtain a metal substrate after the pre-rolling annealing; S3, cleaning the metal substrate after the pre-rolling annealing; S4, stacking a resulting cleaned metal substrate against the highly elastic rubber, followed by rolling using a textured roll; and S5, after the rolling, peeling off the highly elastic rubber to obtain the ultra-thin metal strip with the superficial micro-cup array structure.

### CROSS REFERENCE TO RELATED APPLICATION

This patent application claims the benefit and priority of Chinese Patent Application No. 2024117642216 filed with the China National Intellectual Property Administration (CNIPA) on Dec. 3, 2024, and entitled with “ULTRA-THIN METAL STRIP WITH SUPERFICIAL MICRO-CUP ARRAY STRUCTURE AND PREPARATION METHOD THEREOF”, the disclosure of which is incorporated by reference herein in its entirety as part of the present application.

### TECHNICAL FIELD

The present disclosure relates to the technical filed of ultra-thin metal strips, in particular to an ultra-thin metal strip with a superficial micro-cup array structure and a preparation method thereof.

### BACKGROUND

With the rapid development of the precision machinery and electronics industries, superficial micro-feature structures have gained wide and deep applications in many fields, including aerospace, automotive manufacturing, and high-end equipment. Among these, surface structures with the distribution characteristics of micro-cup arrays are particularly in the spotlight since they can impart unique hydrophobic properties to materials, which is especially valuable in situations where there are strict requirements for liquid permeation or accumulation. Such surface structures play a crucial role due to their excellent water resistance and provide a strong guarantee for the stable operation and performance improvement of equipment, especially in precision fields such as electronic equipment and sensors.

Currently, the formation of the superficial micro-cup array structure mainly relies on high-precision technologies such as laser stamping, laser engraving, and hot coining. Although these methods can achieve the desired structural features, they all require specific templates as a basis for processing, which leads to complex process steps while increasing production costs, and reducing production efficiency. Therefore, these methods are not suitable for large-scale mass production.

Therefore, in the context of pursuing efficient and low-cost manufacturing, the traditional forming technology of micro-deep drawing provides a potential alternative solution. However, the forming technology of micro-deep drawing generally requires using an ultra-thin strip with a thickness of 20-50 μm when making micro-cups. This strict standard of material thickness puts forward higher demands on the accuracy of the equipment, which can be achieved by precisely controlling the processing parameters and using high-quality and high-precision dies. Moreover, the whole operation process is complicated and difficult while the preparation cycle is long, and the prepared micro-cups are separate components that are difficult to directly form an ordered micro-cup array structure on the surface of an ultra-thin metal strip. These problems not only limit the production efficiency of materials with a superficial micro-cup array structure, but also increase process costs, resulting in limited use of materials with a superficial micro-cup array structure.

### SUMMARY

In view of this, the present disclosure provides an ultra-thin metal strip with a superficial micro-cup array structure and a preparation method thereof. The present disclosure enables continuous preparation of the ultra-thin metal strip with the micro-cup array structure and achieves the objects of reducing costs and significantly improving production efficiency. By optimizing the preparation process, the present disclosure overcomes the limitation of the prior art and opens up a new way for large-scale, high-efficiency, and low-cost production of a micro-cup array.

A method for preparing an ultra-thin metal strip with a superficial micro-cup array structure according to the present disclosure, including:
S1, cutting an ultra-thin metal strip and a highly elastic rubber to obtain a metal substrate and a highly elastic rubber strip;
S2, subjecting the metal substrate to pre-rolling annealing to obtain a metal substrate after the pre-rolling annealing;
S3, cleaning the metal substrate after the pre-rolling annealing;
S4, stacking a resulting cleaned metal substrate against the highly elastic rubber, followed by rolling using a textured roll; and
S5, after the rolling, peeling off the highly elastic rubber to obtain the ultra-thin metal strip with the superficial micro-cup array structure.

In some embodiments, the ultra-thin metal strip has a thickness of 5 μm to 100 μm.

In some embodiments, the ultra-thin metal strip is selected from a group consisting of a copper foil, a titanium foil, an aluminum foil, and an alloy strip, preferably, the alloy strip is a stainless steel strip.

In some embodiments, the pre-rolling annealing is conducted at a temperature of 650° C. to 950° C., and the pre-rolling annealing is held at the temperature for 5 min to 15 min.

In some embodiments, the highly elastic rubber is selected from a group consisting of silicone rubber, polyurethane rubber, and fluororubber.

In some embodiments, the resulting cleaned metal substrate is fitted with the textured roll, and the highly elastic rubber is fitted with a flat roll without microstructure.

In some embodiments, the textured roll has a surface roughness of 5 μm to 50 μm.

In some embodiments, the rolling is conducted with a rolling force of 5 kN to 15 kN at a rolling speed of 0.1 m/min to 0.5 m/min.

The present disclosure further provides an ultra-thin metal strip with a superficial micro-cup array structure prepared by the method described above.

The ultra-thin metal strip with a superficial micro-cup array structure according to the present disclosure is used in the field of aerospace, automotive manufacturing, and high-end equipment manufacturing.

Compared with the prior art, the present disclosure successfully prepares a regular micro-cup array structure on the surface of a rolled piece, forming a unique pitted lattice morphology. Compared with the surface produced by a conventional flat rolling process, such a structure enables a significant increase in the contact angle and greatly enhanced hydrophobicity. This characteristic enables the rolled pieces to exhibit unique advantages in high-end application fields such as aerospace and medical apparatuses, and is especially suitable for occasions where there are strict requirements for surface characteristics. The present disclosure also skillfully utilizes the reversible deformation properties of highly elastic rubber. In the rolling process, the highly elastic rubber is elastically deformed under the action of a small external force, providing sufficient space for stretching of the ultra-thin metal strip. It is worth mentioning that in the rolling process, the highly elastic rubber is not compounded with the ultra-thin metal strip, which ensures that the rubber can be easily peeled off the surface of the thin metal strip after rolling, thereby ensuring the high precision and high quality of the micro-cup array structure. This not only improves the quality of the product, but also simplifies the production process. In addition, the present disclosure realizes a continuous rolling process of the micro-cup array on the surface of the ultra-thin metal strip, which greatly improves production efficiency, enables large-scale production, and significantly reduces production costs. The present disclosure shows significant advantages in terms of economic efficiency and industrial application prospects over conventional intermittent or batch production methods.

### BRIEF DESCRIPTION OF THE DRAWINGS

The present disclosure will be further described below with reference to the drawings.

FIG. 1 shows a schematic diagram of a rolling process.

FIG. 2 shows a schematic diagram of peeling off a highly elastic rubber.

FIG. 3 shows a schematic diagram of the surface structure of a textured rolled.

FIG. 4 shows a morphology diagram of the micro-cup array on the surface of a rolled piece.

FIG. 5A to FIG. 5B show three-dimensional profile morphology diagrams of the bottom surface of the micro-cups of the ultra-thin strip of Example 1.

FIG. 6A to FIG. 6B show three-dimensional profile morphology diagrams of the front surface of the micro-cups of the ultra-thin strip of Example 1.

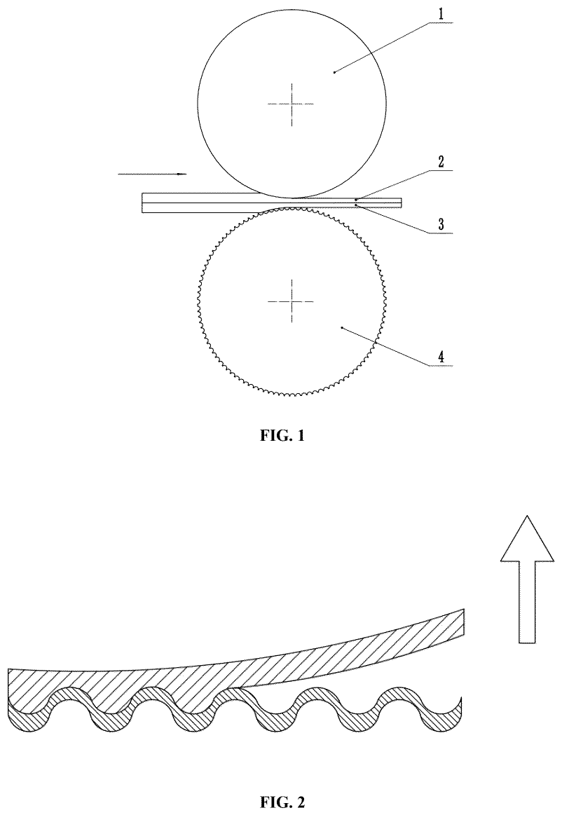

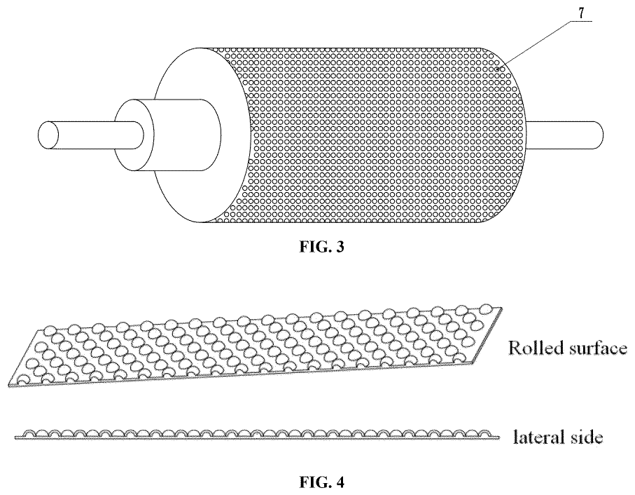

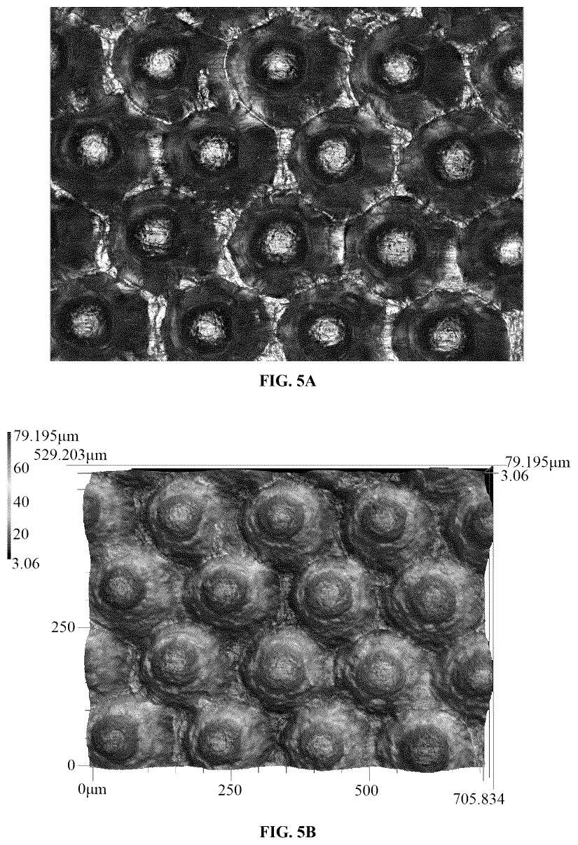

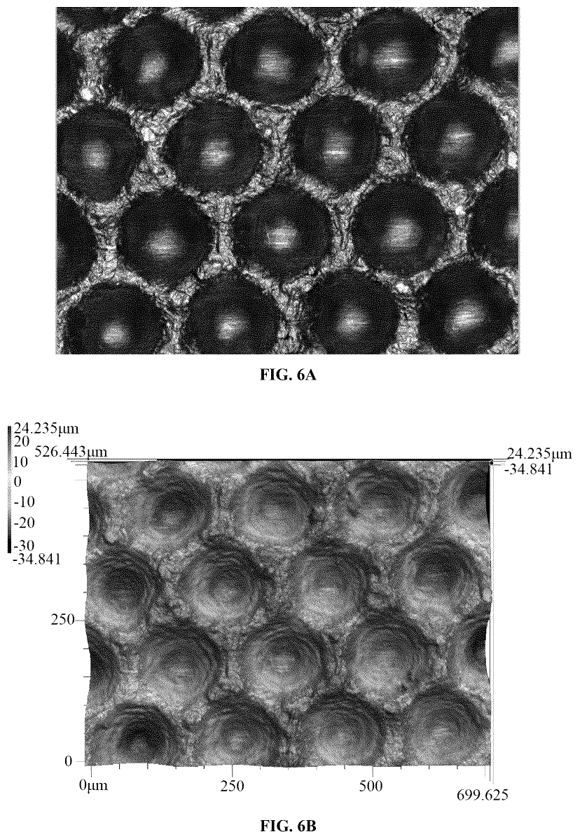

List of reference signs: 1 refers to conventional flat roll; 2 refers to highly elastic rubber; 3 refers to metal substrate; and 4 refers to textured roll.

### DETAILED DESCRIPTION OF THE EMBODIMENTS

The technical solutions of the present disclosure will be described clearly and completely below with reference to the examples of the present disclosure. Obviously, the described examples are only some of, rather than all of, the examples of the present disclosure. On the basis of the examples of the present disclosure, all the other examples that can be obtained by a person of ordinary skill in the art without creative efforts shall fall within the scope of the present disclosure.

A method for preparing an ultra-thin metal strip with a superficial micro-cup array structure provided by the present disclosure, including the following steps:
S1, cutting an ultra-thin metal strip and a highly elastic rubber to obtain a metal substrate and a highly elastic rubber strip;
S2, subjecting the metal substrate to pre-rolling annealing to obtain a metal substrate after the pre-rolling annealing;
S3, cleaning the metal substrate after the pre-rolling annealing;
S4, stacking a resulting cleaned metal substrate against the highly elastic rubber, followed by rolling using a textured roll; and
S5, after the rolling, peeling off the highly elastic rubber to obtain the ultra-thin metal strip with the superficial micro-cup array structure.

In the present disclosure, the first step is conducted by cutting an ultra-thin metal strip and a highly elastic rubber to obtain a metal substrate and a highly elastic rubber strip. Specifically, an ultra-thin metal strip is selected as a composite substrate, and the ultra-thin metal strip and the highly elastic rubber strip are precisely cut to ensure that the dimension of each substrate strip meets the pre-set standard. In some embodiments of the present disclosure, the ultra-thin metal strip has a thickness of 5 μm to 100 μm. In some embodiments of the present disclosure, the ultra-thin metal strip is selected from a group consisting of a copper foil, a titanium foil, an aluminum foil, and an alloy strip. In some embodiments of the present disclosure, the alloy strip is a stainless steel strip. In some embodiments of the present disclosure, the highly elastic rubber is selected from a group consisting of silicone rubber, polyurethane rubber, and fluororubber. The highly elastic rubber material selected and used in the present disclosure not only has good elasticity and abrasion resistance and can maintain a stable shape and size during the rolling, but also can easily separate from the thin metal strip without contamination to the finished product. In some embodiments of the present disclosure, the length, width, and thickness of the highly elastic rubber strip are all equal to or greater than those of the metal substrate.

In the present disclosure, the second step is conducted by subjecting the cut metal substrate to pre-rolling annealing, where the pre-rolling annealing is conducted in an inert gas atmosphere, the pre-rolling annealing is conducted at a temperature of 650° C. to 950° C., and the pre-rolling annealing is held at the temperature for 5 min to 15 min. In some embodiments of the present disclosure, the inert gas is argon; under the condition that the metal substrate is stainless steel, the pre-rolling annealing is conducted at 950° C., and the pre-rolling annealing is held at the temperature for 5 min; under the condition that the metal substrate is a titanium foil, the pre-rolling annealing is conducted at 600° C., and the pre-rolling annealing is held at the temperature for 10 min.

The present disclosure ensures that the microstructure inside the material is optimized by pre-rolling annealing, thus improving the plasticity and rolling performance of the material. Meanwhile, the oxidation of the material during annealing is prevented by controlling the atmosphere.

In the present disclosure, the third step is conducted by cleaning the metal substrate after the pre-rolling annealing. In some embodiments of the present disclosure, the cleaning is conducted with absolute ethanol and a dust-free paper. Specifically, absolute ethanol is sprayed on a surface of the thin strip, and the surface of the thin metal strip is gently wiped with a dust-free paper. The present disclosure ensures good contact between the thin metal strip and the roll during rolling by a cleaning treatment to remove impurities, greasy dirt and other contaminants from the surface of the metal substrate.

In the present disclosure, the fourth step is conducted by stacking a resulting cleaned metal substrate against the highly elastic rubber, followed by rolling. In some embodiments of the present disclosure, the resulting cleaned metal substrate is fitted with the textured roll, and the highly elastic rubber is fitted with a flat roll without microstructure, and then the two substrates are subsequently fed to a flat-roll rolling mill for rolling and compounding, where the textured roll has a roughness of 5 μm to 50 μm. However, in the present disclosure, the roughness of the textured roll is not strictly limited, and the textured rolls of various specifications can be customized according to specific requirements and used for rolling, ultimately aiming to ensure the uniformity and consistency of the surface microstructure of the ultra-thin metal strip. Generally, the thicker the thin strip, the greater the roughness of the corresponding textured roll, so as to form an ideal micro-cup array structure.

In some embodiments of the present disclosure, the rolling is conducted with a rolling force of 5 kN to 15 kN, and the rolling is conducted at a rolling speed of 0.1 m/min to 0.5 m/min.

In the present disclosure, the fifth step is conducted by peeling off the highly elastic rubber from the surface of the thin metal strip. Since the highly elastic rubber material used in the present disclosure has good elasticity and abrasion resistance, it can be easily peeled off without damaging the microstructure on the surface of the thin metal strip, and the highly elastic rubber will not be compounded with the thin metal strip during the rolling process and is easily separated.

The present disclosure further provides an ultra-thin metal strip with a superficial micro-cup array structure prepared by the method described above.

The ultra-thin metal strip with a superficial micro-cup array structure according to the present disclosure is used in the field of aerospace, automotive manufacturing, and high-end equipment manufacturing.

The ultra-thin metal strip of the present disclosure has a superficial micro-cup array structure and can be widely applied to surface coating materials for aircraft (e.g., airplanes, rockets, satellites). Its regular superficial micro-cup array structure can effectively reduce air drag, thereby improving flight efficiency. In addition, the structure also significantly improves the hydrophobicity of the material, which helps to prevent the fuselage from freezing and improves flight safety. In the field of aerospace, the ultra-thin metal strip of the present disclosure can be used as an important component of thermal protection systems, such as a thermal insulation layer or a thermal-resistance tile, which can effectively reduce heat transfer and protect the internal structure from high-temperature damage due to its regular structure and superior hydrophobicity. In the automotive industry, the ultra-thin metal strip of the present disclosure can be used as a surface coating of the vehicle body, which can reduce air resistance and improve fuel efficiency. At the same time, its excellent hydrophobicity helps to prevent the accumulation of water on the vehicle body, reducing the risk of corrosion and abrasion. In addition, in radar and communication systems, the ultra-thin metal strip of the present disclosure can be used in radome materials, with the micro-cup array structure on the surface its reducing the reflection and scattering of electromagnetic waves, thus improving the quality of signal transmission and enhancing system performance.

To further illustrate the present disclosure, it will be described in detail by the following examples. The raw materials used in the following examples of the present disclosure are all commercially available. Unless otherwise specified, all tests are repeated 3 times, and the results are expressed as averages.

### Example 1

An ultra-thin 304 stainless steel strip with a superficial micro-cup array structure was prepared by a method consisting of the following steps:
S1. An ultra-thin 304 stainless steel strip with a thickness of 20 μm was precisely cut as a metal substrate, where the metal substrate had a specification of 130 mm×15 mm. A silicone rubber with a thickness of 50 μm was precisely cut to obtain a silicone rubber strip, where the silicone rubber strip had a specification of 140 mm×16 mm.
S2. The metal substrate was placed in an annealing furnace, heated to 950° C., and subjected to annealing treatment under a strictly controlled argon-protective atmosphere, and the metal substrate was held at the temperature for 5 min.
S3. Absolute ethanol was sprayed on a surface of the thin strip, and the surface of the thin metal strip was gently wiped with a dust-free paper to remove residual greasy dirt and impurities.
S4. A resulting cleaned metal substrate was stacked against the silicone rubber strip, where the metal substrate side closely fitted with a textured roll having a roughness of 20 μm, and the silicone rubber strip on the other side fitted with a smooth flat roll, and then rolled with a rolling force of 14 kN and a rolling speed of 0.1 m/min.
S5. After the rolling, a resulting highly elastic rubber was peeled off from the surface of the metal substrate to obtain an ultra-thin 304 stainless steel strip with a superficial micro-cup array structure.

Upon detection, the ultra-thin 304 stainless steel strip prepared in this example had a contact angle of 80°.

### Example 2

An ultra-thin 304 stainless steel strip with a superficial micro-cup array structure was prepared by a method consisting of the following steps:
S1. An ultra-thin 304 stainless steel strip with a thickness of 10 μm was precisely cut as a metal substrate, where the metal substrate had a specification of 130 mm×15 mm. A silicone rubber with a thickness of 50 μm was precisely cut to obtain a silicone rubber strip, where the silicone rubber strip had a specification of 140 mm×16 mm.
S2. The metal substrate was placed in an annealing furnace, heated to 950° C., and subjected to annealing treatment under a strictly controlled argon-protective atmosphere, and the metal substrate was held at the temperature for 5 min.
S3. spraying absolute ethanol on the surface of the thin strip, and gently wiping the surface of the thin metal strip with dust-free paper to remove residual greasy dirt and impurities;
S4. A resulting cleaned metal substrate was stacked against the silicone rubber strip, where the metal substrate side closely fitted with a textured roll having a roughness of 10 μm, and the silicone rubber strip on the other side fitted with a smooth flat roll, and then rolled with a rolling force of 12 kN and a rolling speed of 0.1 m/min.
S5. After the rolling, a resulting highly elastic rubber was peeled off from the surface of the metal substrate to obtain an ultra-thin 304 stainless steel strip with a superficial micro-cup array structure.

Upon detection, the ultra-thin 304 stainless steel strip prepared in this example had a contact angle of 65°.

### Example 3

An ultra-thin 304 stainless steel strip with a superficial micro-cup array structure was prepared by a method consisting of the following steps:
S1. An ultra-thin 304 stainless steel strip with a thickness of 50 μm was precisely cut as a metal substrate, where the metal substrate had a specification of 130 mm×15 mm. A silicone rubber with a thickness of 100 μm was precisely cut to obtain a silicone rubber strip, where the silicone rubber strip had a specification of 140 mm×16 mm.
S2. The metal substrate was placed in an annealing furnace, heated to 950° C., and subjected to annealing treatment under a strictly controlled argon-protective atmosphere, and the metal substrate was held at the temperature for 5 min,
S3. Absolute ethanol was sprayed on a surface of the thin strip, and the surface of the thin metal strip was gently wiped with a dust-free paper to remove residual greasy dirt and impurities.
S4. A resulting cleaned metal substrate was stacked against the silicone rubber strip, where the metal substrate side closely fitted with a textured roll having a roughness of 50 μm, and the silicone rubber strip on the other side fitted with a smooth flat roll, and then rolled with a rolling force of 16 kN and a rolling speed of 0.1 m/min.
S5. After the rolling, a resulting highly elastic rubber was peeled off from the surface of the metal substrate to obtain an ultra-thin 304 stainless steel strip with a superficial micro-cup array structure.

Upon detection, the ultra-thin 304 stainless steel strip prepared in this example had a contact angle of 85°.

### Example 4

An ultra-thin titanium strip with a superficial micro-cup array structure was prepared by a method consisting of the following steps:
S1. An ultra-thin titanium foil strip with a thickness of 20 μm was precisely cut as a metal substrate, where the metal substrate had a specification of 130 mm×15 mm. A silicone rubber with a thickness of 50 μm was precisely cut to obtain a silicone rubber strip, where the silicone rubber strip had a specification of 140 mm×16 mm.
S2. The metal substrate was placed in an annealing furnace, heated to 650° C., and subjected to annealing treatment under a strictly controlled argon-protective atmosphere, and the metal substrate was held at the temperature for 10 min.
S3. Absolute ethanol was sprayed on a surface of the thin strip, and the surface of the thin metal strip was gently wiped with a dust-free paper to remove residual greasy dirt and impurities.
S4. A resulting cleaned metal substrate was stacked against the silicone rubber strip, where the metal substrate side closely fitted with a textured roll having a roughness of 20 μm, and the silicone rubber strip on the other side fitted with a smooth flat roll, and then rolled with a rolling force of 10 kN and a rolling speed of 0.1 m/min.
S5. After the rolling, a resulting highly elastic rubber was peeled off from the surface of the metal substrate to obtain an ultra-thin titanium foil strip with a superficial micro-cup array structure.

Upon detection, the ultra-thin titanium foil strip prepared in this example had a contact angle of 80°.

### Example 5

An ultra-thin titanium strip with a superficial micro-cup array structure was prepared by a method consisting of the following steps:
S1. An ultra-thin titanium foil strip with a thickness of 10 μm was precisely cut as a metal substrate, where the metal substrate had a specification of 130 mm×15 mm. A silicone rubber with a thickness of 50 μm was precisely cut to obtain a silicone rubber strip, where the silicone rubber strip had a specification of 140 mm×16 mm.
S2. The metal substrate was placed in an annealing furnace, heated to 650° C., and subjected to annealing treatment under a strictly controlled argon-protective atmosphere, and the metal substrate was held at the temperature for 10 min.
S3. Absolute ethanol was sprayed on a surface of the thin strip, and the surface of the thin metal strip was gently wiped with a dust-free paper to remove residual greasy dirt and impurities.
S4. A resulting cleaned metal substrate was stacked against the silicone rubber strip, where the metal substrate side closely fitted with a textured roll having a roughness of 10 μm, and the silicone rubber strip on the other side fitted with a smooth flat roll, and then rolled with a rolling force of 8 kN and a rolling speed of 0.1 m/min.
S5. After the rolling, a resulting highly elastic rubber was peeled off from the surface of the metal substrate to obtain an ultra-thin titanium foil strip with a superficial micro-cup array structure.

Upon detection, the ultra-thin titanium foil strip prepared in this example had a contact angle of 70°.

### Example 6

An ultra-thin copper strip with a superficial micro-cup array structure was prepared by a method consisting of the following steps:
S1. A copper foil with a thickness of 50 μm was precisely cut as a metal substrate, where the metal substrate had a specification of 130 mm×15 mm. A silicone rubber with a thickness of 100 μm was precisely cut to obtain a silicone rubber strip, where the silicone rubber strip had a specification of 140 mm×16 mm.
S2. The metal substrate was placed in an annealing furnace, heated to 500° C., and subjected to annealing treatment under a strictly controlled argon-protective atmosphere, and the metal substrate was held at the temperature for 5 min.
S3. Absolute ethanol was sprayed on a surface of the thin strip, and the surface of the thin metal strip was gently wiped with a dust-free paper to remove residual greasy dirt and impurities.
S4. A resulting cleaned metal substrate was stacked against the silicone rubber strip, where the metal substrate side closely fitted with a textured roll having a roughness of 50 μm, and the silicone rubber strip on the other side fitted with a smooth flat roll, and then rolled with a rolling force of 6 kN and a rolling speed of 0.1 m/min.
S5. After the rolling, a resulting highly elastic rubber was peeled off from the surface of the metal substrate to obtain an ultra-thin copper strip with a superficial micro-cup array structure.

Upon detection, the ultra-thin copper strip prepared in this example had a contact angle of 85°.

### Example 7

An ultra-thin aluminium strip with a superficial micro-cup array structure was prepared by a method consisting of the following steps:
S1. An aluminium foil with a thickness of 50 μm was precisely cut as a metal substrate, where the metal substrate had a specification of 130 mm×15 mm. A silicone rubber with a thickness of 100 μm was precisely cut to obtain a silicone rubber strip, where the silicone rubber strip had a specification of 140 mm×16 mm.
S2. The metal substrate was placed in an annealing furnace, heated to 300° C., and subjected to annealing treatment under a strictly controlled argon-protective atmosphere, and the metal substrate was held at the temperature for 5 min.
S3. Absolute ethanol was sprayed on a surface of the thin strip, and the surface of the thin metal strip was gently wiped with a dust-free paper to remove residual greasy dirt and impurities.
S4. A resulting cleaned metal substrate was stacked against the silicone rubber strip, where the metal substrate side closely fitted with a textured roll having a roughness of 50 μm, and the silicone rubber strip on the other side fitted with a smooth flat roll, and then rolled with a rolling force of 5 kN and a rolling speed of 0.1 m/min.
S5. After the rolling, a resulting highly elastic rubber was peeled off from the surface of the metal substrate to obtain a copper foil with a superficial micro-cup array structure.

Upon detection, the ultra-thin aluminium strip prepared in this example had a contact angle of 80°.

### Comparative Example 1

An ultra-thin 304 stainless steel strip was prepared by a method consisting of the following steps:
S1. An ultra-thin 304 stainless steel strip with a thickness of 20 μm was precisely cut as a metal substrate, where the metal substrate had a specification of 130 mm×15 mm. A silicone rubber with a thickness of 50 μm was precisely cut to obtain a silicone rubber strip, where the silicone rubber strip had a specification of 140 mm×16 mm.
S2. The metal substrate was placed in an annealing furnace, heated to 950° C., and subjected to annealing treatment under a strictly controlled argon-protective atmosphere, and the metal substrate was held at the temperature for 5 min.
S3. Absolute ethanol was sprayed on a surface of the thin strip, and the surface of the thin metal strip was gently wiped with a dust-free paper to remove residual greasy dirt and impurities.
S4. A resulting cleaned metal substrate was stacked against the silicone rubber strip, where the metal substrate and the silicone rubber strip both fitted with smooth flat rolls, and then rolled with a rolling force of 14 kN and a rolling speed of 0.1 m/min.
S5. After the rolling, a resulting highly elastic rubber was peeled off from the surface of the metal substrate to obtain an ultra-thin 304 stainless steel strip with a superficial micro-cup array structure.

Upon detection, the ultra-thin 304 stainless steel strip prepared in this comparative example had a contact angle of 30°.

### Comparative Example 2

An ultra-thin titanium strip with a superficial micro-cup array structure was prepared by a method consisting of the following steps:
S1. An ultra-thin titanium foil strip with a thickness of 20 μm was precisely cut as a metal substrate, where the metal substrate had a specification of 130 mm×15 mm. A silicone rubber with a thickness of 50 μm was precisely cut to obtain a silicone rubber strip, where the silicone rubber strip had a specification of 140 mm×16 mm.
S2. The metal substrate was placed in an annealing furnace, heated to 650° C., and subjected to annealing treatment under a strictly controlled argon-protective atmosphere, and the metal substrate was held at the temperature for 5 min.
S3. Absolute ethanol was sprayed on a surface of the thin strip, and the surface of the thin metal strip was gently wiped with a dust-free paper to remove residual greasy dirt and impurities.
S4. A resulting cleaned metal substrate was stacked against the silicone rubber strip, where the metal substrate and the silicone rubber strip both fitted with smooth flat rolls, and then rolled with a rolling force of 10 kN and a rolling speed of 0.1 m/min.
S5. After the rolling, a resulting highly elastic rubber was peeled off from the surface of the metal substrate to obtain an ultra-thin titanium foil strip with a superficial microc-up array structure.

Upon detection, the ultra-thin titanium foil strip prepared in this comparative example had a contact angle of 30°.

The above examples merely represent several embodiments of the present disclosure, giving specific and detailed description, but should not be understood as limiting the scope of the present patent of invention thereby. It should be noted that several variations and improvements could also be made by a person of ordinary skill in the art without departing from the spirit of the present disclosure, and these all fall within the scope of the present disclosure. Therefore, the scope of the present patent of invention shall be in accordance with the appended claims.

What is claimed is:

1. A method for preparing an ultra-thin metal strip with a superficial microcup array structure, comprising:
S1, cutting an ultra-thin metal strip and a highly elastic rubber to obtain a metal substrate and a highly elastic rubber strip;
S2, subjecting the metal substrate to pre-rolling annealing to obtain a metal substrate after the pre-rolling annealing;
S3, cleaning the metal substrate after the pre-rolling annealing;
S4, stacking a resulting cleaned metal substrate against the highly elastic rubber, followed by rolling using a textured roll; and
S5, after the rolling, peeling off the highly elastic rubber to obtain the ultra-thin metal strip with the superficial micro-cup array structure.

2. The method of claim 1, wherein the ultra-thin metal strip has a thickness of 5 μm to 100 μm.

3. The method of claim 1, wherein the ultra-thin metal strip is selected from a group consisting of a copper foil, a titanium foil, an aluminum foil, and an alloy strip.

4. The method of claim 3, wherein the alloy strip is a stainless steel strip.

5. The method of claim 1, wherein the pre-rolling annealing is conducted at a temperature of 650°C to 950°C, and the pre-rolling annealing is held at the temperature for 5 min to 15 min.

6. The method of claim 1, wherein the highly elastic rubber is selected from a group consisting of silicone rubber, polyurethane rubber, and fluororubber.

7. The method of claim 1, wherein the resulting cleaned metal substrate is fitted with the textured roll, and the highly elastic rubber is fitted with a flat roll without microstructure.

8. The method of claim 1, wherein the rolling is conducted with a rolling force of 5 kN to 15 kN at a rolling speed of 0.1 m/min to 0.5 m/min.

9. The method of claim 1, wherein the textured roll has a surface roughness of 5 μm to 50 μm.

10. An ultra-thin metal strip with a superficial micro-cup array structure prepared by the method of claim 1.

11. The ultra-thin metal strip with the superficial micro-cup array structure of claim 10, wherein the ultra-thin metal strip has a thickness of 5 μm to 100 μm.

12. The ultra-thin metal strip with the superficial micro-cup array structure of claim 10, wherein the ultra-thin metal strip is selected from a group consisting of a copper foil, a titanium foil, an aluminum foil, and an alloy strip.

13. The ultra-thin metal strip with the superficial micro-cup array structure of claim 10, wherein the alloy strip is a stainless steel strip.

14. The ultra-thin metal strip with the superficial micro-cup array structure of claim 10, wherein the pre-rolling annealing is conducted at a temperature of 650°C to 950°C, and the pre-rolling annealing is held at the temperature for 5 min to 15 min.

16. The ultra-thin metal strip with a superficial micro-cup array structure of claim 10, wherein the highly elastic rubber is selected from a group consisting of silicone rubber, polyurethane rubber, and fluororubber.

17. The ultra-thin metal strip with a superficial micro-cup array structure of claim 10, wherein the resulting cleaned metal substrate is fitted with the textured roll, and the highly elastic rubber is fitted with a flat roll without microstructure.

18. The ultra-thin metal strip with the superficial micro-cup array structure of claim 10, wherein the rolling is conducted with a rolling force of 5 kN to 15 kN at a rolling speed of 0.1 m/min to 0.5 m/min.

19. The ultra-thin metal strip with the superficial micro-cup array structure of claim 10, wherein the textured roll has a surface roughness of 5 μm to 50 μm.
